(19) United States
(12) Patent Application Publication
(10) Pub. No.: US 2005/0121883 A1
(43) Pub. Date: Jun. 9, 2005

(54) Gas bag module

(75) Inventors: Jurgen Joos, Konigsbronn (DE); Joachim Lutz, Schechingen (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive GmbH

(21) Appl. No.: 10/984,735

(22) Filed: Nov. 9, 2004

(30) Foreign Application Priority Data
Nov. 21, 2003 (DE) 103 54 560.3

(51) Int. Cl. B60R 21/26

(52) U.S. Cl. 280/728.2

(57) ABSTRACT

A gas bag module has a module housing including a mount for accommodating a gas bag arranged therein, a rear wall, and a gas bag exit side lying opposite to the rear wall. A gas generator is located outside the module housing, and a gas conduit which is connected by an inflow end to the gas generator, extends through the rear wall towards the gas bag exit side and has an outflow region at its free end.

### TECHNICAL FIELD

The invention relates to a gas bag module.

### BACKGROUND OF THE INVENTION

It is known to use a gas conduit, also called gas lance, in order to direct gas for inflating the gas bag into the same upon an activation of the gas bag module. This concept has so far been implemented mainly in side gas bag modules arranged along a roof frame of a vehicle. The advantage of using a gas conduit resides in the fact that the gas generator does not have to be located directly in the gas bag module but may either be placed at another location in the vehicle or also in the immediate vicinity of the gas bag module, but at a location that is more favourable for the utilization of space. The gas conduit does not only have to be firmly and gas-tightly connected to the gas generator but also to any gas distribution elements. So far, this has been effected in most cases by welding, which however involves a lot of work and thus high costs.

### BRIEF SUMMARY OF THE INVENTION

It is an object of the invention to provide an inexpensive gas bag module in which the gas used for inflating the gas bag is introduced into the gas bag via a gas conduit.

This is achieved in a gas bag module having a module housing including a mount for accommodating a gas bag arranged therein, a rear wall, and a gas bag exit side lying opposite to the rear wall. A gas generator is located outside the module housing, and a gas conduit which is connected by an inflow end to the gas generator, extends through the rear wall towards the gas bag exit side and has an outflow region at its free end. The gas generator is located completely outside the module housing, and the gas conduit has an outflow region at its free end only.

A simple fastening of a gas deflection member is created according to one embodiment in that the gas conduit is inserted at the inflow end through an opening in a gas guiding plate arranged in the gas bag and presses by a flange against an inner side of the gas guiding plate. This connection is very simple, because the gas conduit acts like a screw whose head is formed by the outflow region. The resulting form-fitting and non-positive fastening of the gas conduit can be carried out very cost-effectively as compared to the weld joint used in the prior art. The joint is formed in that the gas conduit carries a flange below the outflow region (e.g. an integrally molded flange or a washer) which preferably has a larger diameter than the outflow region. A further fastening of the gas conduit at the gas guiding plate is not absolutely necessary when the gas conduit is firmly fixed at the housing. The required gas-tightness is ensured as well, because the gas leaves the gas conduit through the outflow region above the flange and is guided via the latter directly onto the gas guiding plate.

The gas guiding plate is preferably designed at least in sections in the shape of a trough, the outflow region being located within the trough-shaped section. The walls of the trough-shaped section keep the hot gas away from the walls of the gas bag while the shape of the trough open upwardly ensures that the gas is able to escape into the gas bag over a large area. The gas conduit is inserted from the upper open side of the trough through the opening provided in the bottom of the trough.

The depth of the trough may decrease towards the ends of the gas guiding plate, the possibility existing to provide fastening means here for the gas guiding plate at the housing. Also by means of this fashioning the gas flow is guided in such a manner that the hot gas comes into contact with the walls of the gas bag as little as possible. Moreover, the gas guiding plate may at the same time be used for fastening the gas bag at the housing.

In order to achieve a maximum possible neutrality of thrust, the outflow region preferably comprises several radial outflow openings which are arranged in such a manner that the impulses of the partial gas flows flowing out of the individual outflow openings cancel each other out and there is a neutrality of thrust. One possibility to achieve this in a simple manner is to arrange the outflow openings at the upper end of the gas conduit radially and at the same angular distance. Four or five outflow openings may for example be provided.

Preferably, the gas generator is located on the underside of the mount, i.e. on the outside of the housing and not within the gas bag, which increases the flexibility of the fashioning of the gas bag module.

For a gas bag module designed to be as compact as possible the mount may have an elongated form and the gas guiding plate may be located offset in relation to an imaginary center line of the mount. By means of this arrangement the depth of the mount may be kept smaller on the side of the imaginary center line on which the gas guiding plate is arranged than on the other side of the imaginary center line. The gas generator may then be arranged below the shallower side of the mount.

For rapidly introducing a large amount of gas into the section of the gas bag which lies in a folded state on the deeper side of the mount, a portion of a side wall of the trough-shaped section facing towards the inside of the mount is preferably lowered.

Preferably, the gas conduit is firmly connected to the gas generator. The fastening is effected e.g. in that the gas conduit comprises an inflow region at the inflow end, and the gas generator is cylindrical and comprises a continuous opening perpendicular to a longitudinal axis and the gas conduit extends through the gas generator, the inflow region being located in the interior of the gas generator. The inflow end of the gas conduit at which the inflow region is formed may also be connected to the gas generator in a form-fitting manner or may for example be screwed to the latter. This fastening is preferably effected in that the inflow end extends through the gas generator and a nut and bolt connection is provided in this region by means of which an axial clamping force is exerted on the gas guiding plate and the gas generator. This means that the parts between the flange at the gas conduit and the nut and bolt connection are clamped and positioned with respect to each other, as in a screw-type connection. Not only the gas generator and the gas guiding plate but also the housing and the gas generator, if necessary, may be clamped in this manner.

The part of the gas conduit projecting into the outer housing preferably extends linearly and is spaced away both axially and radially from the gas bag folded into a package in order to form an empty space.

### BRIEF DESCRIPTION OF THE DRAWINGS

FIG. 1 shows a schematic perspective view of a gas bag module in accordance with the invention, illustrated without a gas bag for reasons of clarity, in which the outflow region of the gas conduit is configured according to a first variant;

FIG. 2 shows the gas bag module of FIG. 1, the design of the outflow region of the gas conduit being varied with respect to FIG. 1;

FIG. 3 shows a perspective view of a gas bag module in accordance with the invention seen from above at an angle;

FIG. 4 shows a perspective view of the gas bag module in accordance with the invention of FIG. 3 from below at an angle;

FIG. 5 shows a sectional view of a gas bag module in accordance with the invention along the line V-V in FIG. 2;

FIG. 6 shows a sectional view along the line VI-VI in FIG. 2;

FIG. 7 shows a perspective view of a gas guiding plate connected to a gas conduit for use in a gas bag module in accordance with the invention;

FIG. 8 shows a schematic side view of the assembly unit of FIG. 7;

FIG. 9 shows a perspective view of the gas conduit and the gas guiding plate according to FIG. 7;

FIG. 10 shows a schematic side view of a gas bag module according to a further embodiment;

FIG. 11 shows a perspective view onto the gas bag module of FIG. 10;

FIG. 12 shows a side view of the front face of the gas bag module of FIG. 10; and

FIG. 13 shows a side view of the gas bag module according to FIG. 10 with the gas bag in the inflated state.

### DETAILED DESCRIPTION OF THE PREFERRED EMBODIMENTS

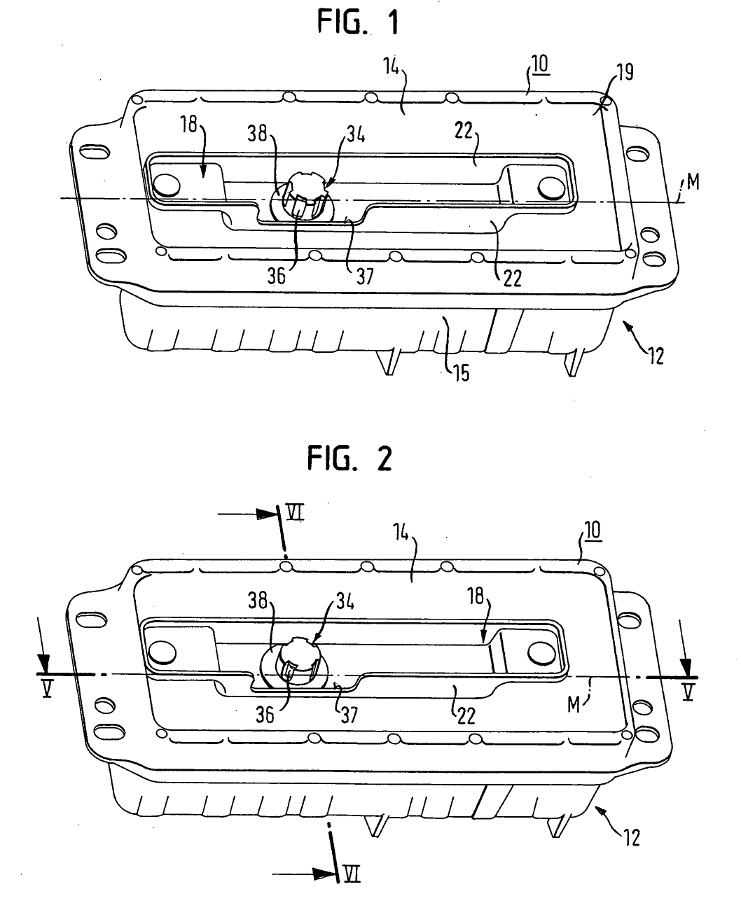

The module housing 10 (outer housing) of the gas bag module 12 shown in FIG. 1 comprises a mount 14 which is defined by walls of the housing 10 and in which a folded gas bag 16 (schematically shown in FIG. 6) is accommodated. A side wall 15 extends from a stepped rear wall 17 of the housing 10, which is opposite to a gas bag exit side 19 (see FIG. 6).

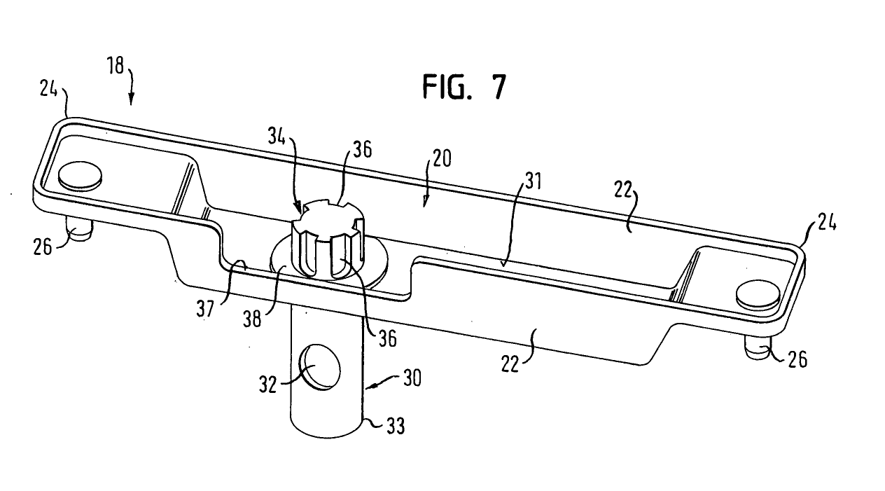

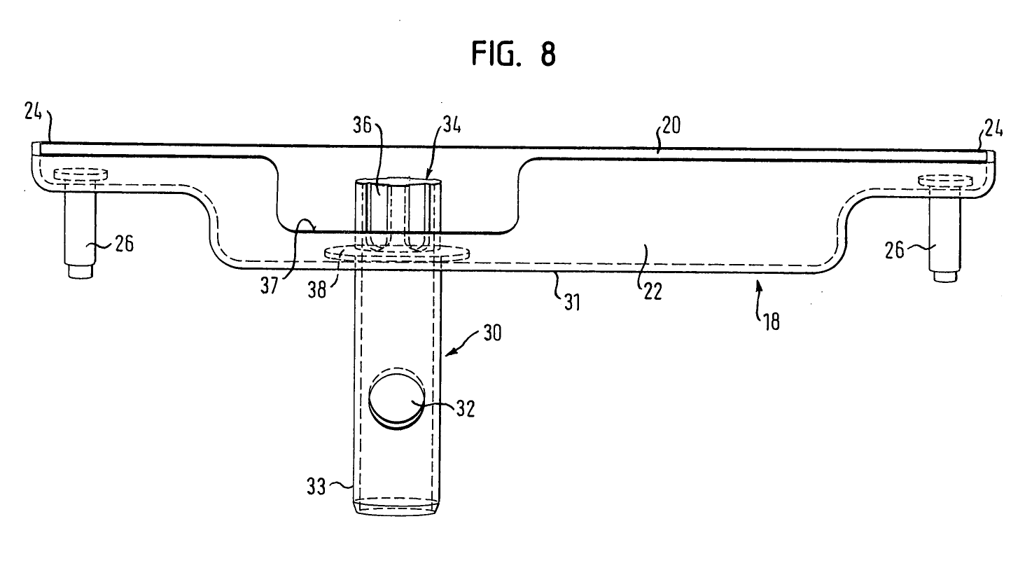

A gas guiding plate 18 is arranged in the mount 14 and within the gas bag 16, namely offset from an imaginary center line M of the mount 14. The gas guiding plate 18 comprises a trough-shaped inner section 20 (see e.g. FIGS. 7 to 9) whose side walls 22 oriented parallel to the walls of the mount 14 guide the gas intended for inflating the gas bag 16 on its way into the gas bag 16. The trough-shaped section into which the gas bag 16 does not project forms a diffuser space for the gas streaming in.

The gas guiding plate 18 is flattened at both ends 24 and provided with fastening elements in the form of fastening bolts 26 by means of which it may be secured to the housing 10. The rim of an inflation opening of the gas bag 16 may be clamped over a large surface area between the bottom of the housing 10 and the bottom of the trough-shaped section 20 of the gas guiding plate 18. Additionally, the gas bag 16 may be provided with openings through which the fastening bolts 26 project in order to safely connect the gas bag to the housing 10.

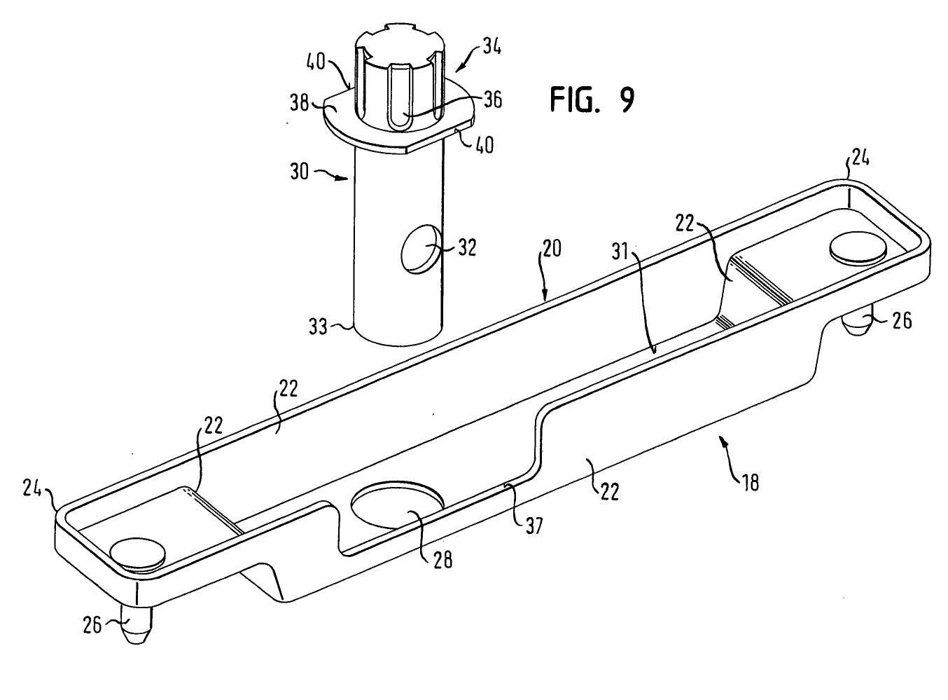

The bottom of the gas guiding plate 18 comprises an opening 28 which is located slightly offset from the center of the trough-shaped section 20 towards one of the ends 24 (see FIG. 9).

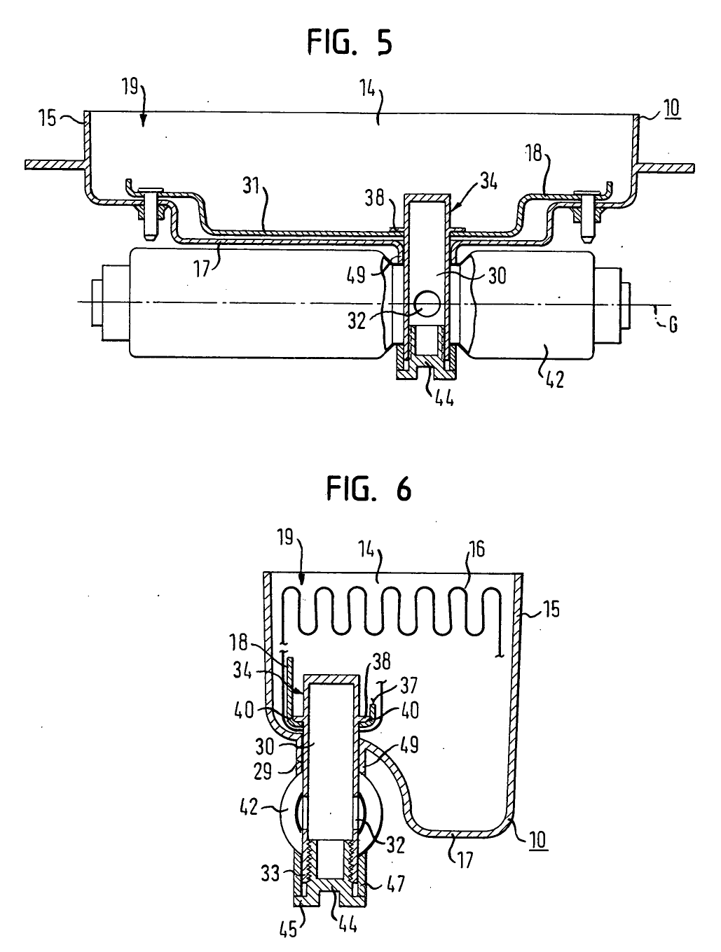

A gas conduit 30 extends through this opening 28 and through an opening 29 in the rear wall 17 of the housing 10 (see e.g. FIG. 6). Simultaneously, the gas conduit 30 extends substantially perpendicular to a flat bottom 31 of the trough-shaped section 20 (see e.g. FIGS. 5 and 7) and is inserted, with its inflow end 33 ahead, through the gas guiding plate 18.

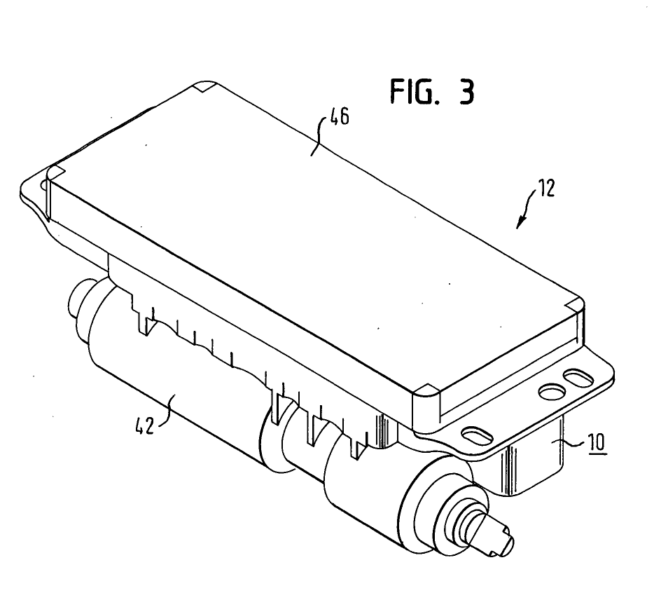

The gas conduit 30 extending completely linearly comprises at its inflow end 33 two openings forming an inflow region 32, while it comprises only at the opposite end an outflow region 34 having several radial outflow openings 36 located in the wall of the gas conduit 30 and distributed at equal angular distances. On account of this arrangement the outflow of the gas from the outflow region 34 is effected practically neutral in thrust, because the impulses of the individual gas flows cancel each other out. As shown in FIG. 1, five outflow openings 36 or, as shown in FIG. 2, four outflow openings 36 may for example be provided. Any number of outflow openings 36 other than the ones described herein are of course conceivable as well.

Directly below the outflow openings 36 the gas conduit carries an annular flange 38 which completely surrounds the gas conduit 30 circumferentially and has a larger diameter than the gas conduit 30 in the region of the outflow openings 36 and the opening 28.

The gas conduit 30 is pushed through the opening 28 in the gas guiding plate 18 so far that the flange 38 rests on the gas guiding plate 18 and completely surrounds the opening 28. In the example shown herein, the circumferential edge of the flange 38 extends on two opposite sides 40 in a straight line, whereby a locking against rotation of the gas conduit 30 with respect to the gas guiding plate 18 is formed in that the sides 40 of the flange 38 are in contact with the side walls 22 of the gas guiding plate 18 (see e.g. also FIG. 6).

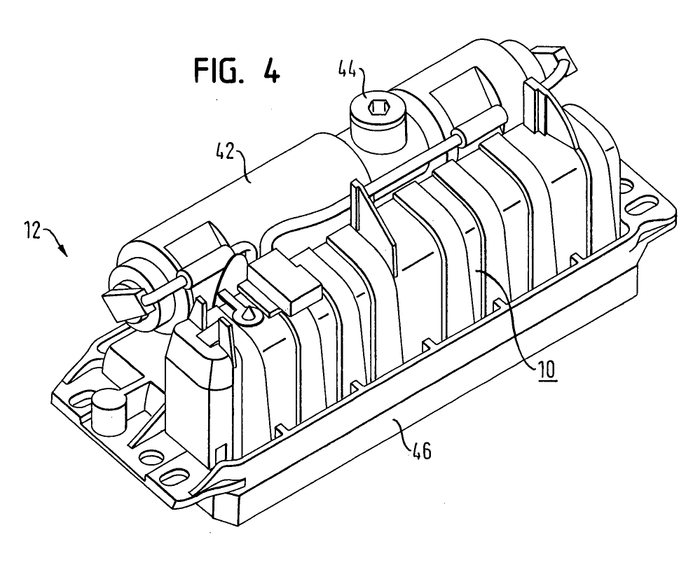

A gas generator 42 is arranged outside the housing 10 below the mount 14. As for example apparent from FIGS. 4 and 6, the gas generator 42 is placed directly below the gas guiding plate, i.e. also offset from the imaginary center line M of the mount 14.

The gas generator 42 has a cylindrical shape and a longitudinal axis G (see FIG. 5). Perpendicular to this longitudinal axis G it comprises a through opening through which the gas conduit 30 projects. The inflow end 33 even sticks out somewhat of the gas generator 42. The gas generator 42 comprises outflow openings (not shown) which are in fluid communication with the inflow region 32 of the gas conduit 30, which is located within the through opening. In the example shown herein, two inflow openings lying opposite one another are provided in the inflow region 32. The exact design of the inflow region is of course up to a person skilled in the art. The gas generator 42 extends with its longitudinal axis G parallel to the longitudinal extension of the elongated housing without protruding with respect to it in top view.

The gas conduit 30 is open on the front face at the inflow end 33. The fastening of the gas conduit 30 at the gas generator 42 is effected via a closure cap 44 screwed into the open end of the gas conduit 30. The closure cap 44 has a radially projecting border 45 (see FIG. 6) pressing against a sleeve 47 which is placed onto the inflow end 33 on the outside and presses against the gas generator 42. Thus, by means of the cap 44 the gas generator 42 is pressed against a downwardly protruding tubular extension 49 at the housing 10. At the same time also the flange 38 is pressed downwards against the gas guiding plate 18 and the latter is pressed together with the gas bag 16 against the inner side of the gas guiding plate 18. Thus, a clamping connection of all parts provided between the flange 38 and the nut and bolt connection at the inflow end 33 is achieved. Of course, further holding elements for fastening the gas generator 42 at the housing 10 may additionally be provided. The gas conduit 30 acts like a traction rod by means of which the gas generator 42 is pressed against the outside of the rear wall 17.

On that side of the center line M below which the gas generator 42 is arranged, the mount 14 is designed to be shallower than on the other side of the center line M. The gas bag 16 completely fills up the mount 14.

A section 37 of the side wall 22 of the gas guiding plate 18 facing towards the interior of the mount 14 is lowered, i.e. the height of the wall is reduced as compared to the remaining trough-shaped section 20.

The lowered section 37 is located in the area of the outflow region 34 resulting in that a large amount of gas directly enters the section of the folded gas bag located in the deeper part of the mount 14.

With the exception of the lowered section 37, the outflow openings 36 are however located below an upper edge of the side walls 22 so that the gas flowing out reaches at first the gas guiding plate 18 before is enters the gas bag 16.

The gas conduit 30 and the gas guiding plate 18 are preferably only fixed at each other via the clamping at the flange 38. Since the gas conduit 30 is firmly connected to the gas generator 42 via the closure cap 44 and thus firmly to the housing 10 and the gas guiding plate 18 is fixed at the housing 10 via the fastening bolts 26, a relative movement of the gas conduit 30 with respect to the gas guiding plate 18 is prevented. Since the flange 38 is located below the outflow region 34 so that no high pressure acts on the connection between the flange 38 and the gas guiding plate 18, the gas tightness is also sufficient.

In assembling the gas bag module 12 the gas conduit is at first inserted into the gas guiding plate and the gas guiding plate placed in the gas bag 16. Then the gas conduit is inserted through the opening 29 in the housing 10 and the inflow region is inserted through the through opening of the gas generator 42, the sleeve 47 is slipped on and the closure cap 44 screwed in.

In FIGS. 3 and 4 the mount 14 is closed by a protective cover 46 opening when the gas bag module 12 is activated.

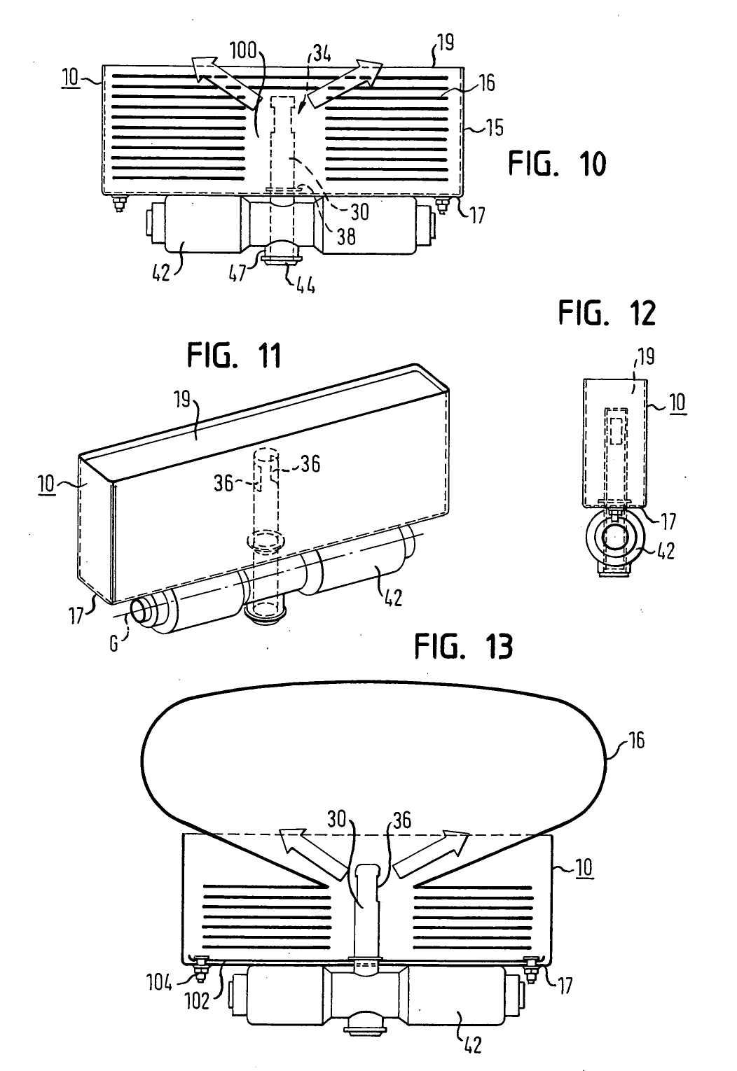

In the embodiment according to FIGS. 10 to 13 the reference numbers already introduced are used again for parts having the same function. Their function is apparent from the foregoing description regarding the first exemplary embodiment.

Also in the embodiment according to FIGS. 10 to 13 the linear gas conduit 30 acts like a traction rod and presses the gas generator 42 against the outside of the rear wall 17. As apparent in particular from FIG. 11, in this arrangement as well the module housing 10 is designed in top view in an elongated form. The gas generator 42 is oriented parallel to the longitudinal direction of the rear wall 17 and, as apparent from FIG. 12, does not protrude laterally relative to the rear wall 17 in top view so that the module is a compact unit.

In this embodiment there is no gas guiding plate 18. The flange 38 presses from above against the rear wall 17. Also in this embodiment the gas conduit 30 extends from the rear wall 17 linearly to the gas bag exit side 19 as well as rectangularly to the gas bag exit side and in the main exit direction of the gas bag. At its end provided in the module housing 10 two outflow openings 36 offset by 180° are provided in the corresponding outflow region 34 (see FIG. 11), which point to the opposite front faces of the outer housing 10 and are thus aligned in longitudinal direction.

The gas conduit 30 extends into the middle of the package to which the gas bag 16 is folded. Around the gas conduit 30 the gas bag package is however spaced away from the latter both in axial and radial direction so that a gas distribution space 100 is formed. Since the outflow openings 36 are located at the upper end of the gas conduit 30 and the latter extends almost up to the gas bag exit side 19 so that only very few layers of the gas bag 16 remain above it, the gas generated by the gas generator 42 flows in the upper airbag package region into the latter. So the gas bag 16 is acted upon by the gas jet marked by arrows near the gas bag exit side 19. Thus, a high friction of gas bag sections lying on top of each other is avoided. The gas bag 16 unfolds, as desired, from close to the gas bag exit side 19, as apparent from FIG. 13. Due to the lateral inflow of gas on account of the outflow openings 36 lying opposite to each other by 180° a rapid deployment in width may take place, which is positive for restraining the occupant. The gas bag deployment starts with a partial volume and the remaining volume of the gas bag package folded in further down follows subsequently.

Incidentally, the gas bag 16 itself is clamped at the rear wall 17 by a simple fastening plate 102 (see FIG. 13) and two insert screws 104.

In all embodiments the gas conduit 30 has a circular cylindrical cross section.

1. A gas bag module comprising:
a module housing (10) including a mount (14) for accommodating a gas bag (16) arranged therein, a rear wall (17), and a gas bag exit side (19) lying opposite to said rear wall (17),
a gas generator (42) located outside said module housing (10), and
a gas conduit (30) connected by an inflow end (33) to said gas generator (42), extending through said rear wall (17) towards said gas bag exit side (19) and having an outflow region (34) at its free end.

2. The gas bag module according to claim 1, wherein said gas conduit (30) carries below said outflow region (34) a disk-shaped flange (38) having a larger diameter than said adjoining outflow region (34).

3. The gas bag module according to claim 2, wherein a gas guiding plate (18) arranged in said gas bag (16) is provided, said gas conduit (30) being inserted at said inflow end (33) through an opening (28) in said gas guiding plate (18) and pressing against an inner side of said gas guiding plate (18) by a flange (38).

4. The gas bag module according to claim 3, wherein said gas guiding plate (18) is designed at least in sections in a shape of a trough and in that said outflow region (34) is located within said trough-shaped section (20).

5. The gas bag module according to claim 4, wherein said depth of said trough decreases towards the ends (24) of said gas guiding plate (18).

6. The gas bag module according to claim 4, wherein said trough-shaped gas guiding plate (18) has an open side lying opposite to a bottom of said gas guiding plate (18) provided with said opening (28).

7. The gas bag module according to claim 1, wherein fastening elements engage said gas guiding plate (18), which connect said gas guiding plate (18) to said housing (10).

8. The gas bag module according to claim 1, wherein said outflow region (34) comprises several radial outflow openings (36) arranged in such a manner that said gas conduit (30) is neutral in thrust.

9. The gas bag module according to claim 1, wherein said gas generator (42) is arranged on an underside of said mount (14).

10. The gas bag module according to claim 1, wherein said mount (14) has an elongated shape and said gas guiding plate (18) is arranged offset from an imaginary center line (M) of said mount (14).

11. The gas bag module according to claim 10, wherein a depth of said mount (14) is less on a side of said imaginary center line (M) on which said gas guiding plate (18) is arranged than on the other side of said imaginary center line (M).

12. The gas bag module according to claim 10, wherein a section (37) of a side wall (22) of said housing (10) facing towards an interior of said mount (14) is lowered.

13. The gas bag module according to claim 1, wherein said gas conduit (30) comprises an inflow region (32) at said inflow end and said inflow end partially projects through said gas generator (42).

14. The gas bag module according to claim 3, wherein asection of said inflow end (33) projects out of said gas generator (42), said section being part of a nut and bolt connection by means of which an axial clamping force is exerted on said gas guiding plate (18) and said gas generator (42).

15. The gas bag module according to claim 14, wherein by means of a nut and bolt connection said gas guiding plate (18), said housing (10) and said gas generator (42) are clamped in axial direction.

16. The gas bag module according to claim 1, wherein said gas generator (42) is cylindrical and comprises a continuous opening perpendicular to its longitudinal axis (G).

17. The gas bag module according to claim 1, wherein said rear wall and said gas generator (42) are elongated and oriented parallel to one another.

18. The gas bag module according to claim 1, wherein at least a part of said gas conduit (30) projects into said outer housing (10) and extends linearly and has a circular cylindrical cross section.

19. The gas bag module according to claim 1, wherein a part of said gas conduit (30) projects into said outer housing (10) and is spaced away from said gas bag (16) folded into a package both axially and radially for forming an empty space (100).

20. The gas bag module according to claim 1, wherein said gas generator (42) is secured at said housing (10) by means of said gas conduit (30).
